(19) United States
(12) Patent Application Publication
(10) Pub. No.: US 2026/0126613 A1
(43) Pub. Date: May 7, 2026

(54) VIRTUAL REALITY GLASSES

(71) Applicant: AAC Microtech (Changzhou) Co., Ltd., Changzhou City (CN)

(72) Inventors: Jinguo Wu, Changzhou (CN); Sensen Yang, Changzhou (CN); Feng Yan, Changzhou (CN); Junsheng Wang, Changzhou (CN)

(21) Appl. No.: 19/189,304

(22) Filed: Apr. 25, 2025

Related U.S. Application Data
(63) Continuation of application No. PCT/CN2024/129399, filed on Nov. 1, 2024.

(51) Int. Cl. G02B 7/12

(52) U.S. Cl. CPC G02B 7/12

(57) ABSTRACT

Embodiments of the present disclosure provide VR glasses including a bracket body, a first mounting hole and a second mounting hole, and a first lens module and a second lens module respectively mounted in the first mounting hole and the second mounting hole. The VR glasses include a driving module. The driving module includes a frame fixed to the bracket body, a driving unit fixed to one side of the frame, a gear member rotatably disposed in the frame and torque-transmissively connected to the driving unit, a first rack meshed with the gear member, and a second rack meshed with the gear member. The VR glasses can automatically and synchronously adjust the interpupillary distance, and has high adjustment accuracy, small volume occupation, high driving efficiency, high reliability, and good user experience.

### CROSS REFERENCE TO RELATED APPLICATIONS

The present application is a continuation of PCT patent application No. PCT/CN2024/129399, entitled “VIRTUAL REALITY GLASSES”, filed on November 1, 2024, which is incorporated herein by reference to its entirety.

### TECHNICAL FIELD

The present disclosure relates to the technical field of virtual reality (VR), and in particular to VR glasses.

### BACKGROUND

VR head-mounted display device is a product that uses simulation technology, computer graphics, human interface technology, multimedia technology, sensing technology, network technology, and other technologies. It is a new means of human-machine interaction created with the help of computers and the latest sensor technology. VR glasses not only allow every enthusiast to experience with surprise and joy, but also fascinate them deeply due to the unknown of its birth and prospects.

The VR glasses in the related technology include a bracket body, a left lens module and a right lens module arranged on the bracket body, an adjustment mechanism for adjusting the interpupillary distance of the left lens module and the right lens module, and a head-mounted structure fixed to the bracket body. The adjustment mechanism includes a gear transmission component and two racks that are torque-transmissively connected to the gear transmission component. The two racks are connected to the left and right lens modules, respectively. The head-mounted structure is placed on the user's head so that the left and right eyes correspond to the left and right lens modules, respectively. By driving the adjustment mechanism to move the two racks, the interpupillary distance between the left and right lens modules can be adjusted, improving the VR experience.

The VR glasses in the related technology adjust the interpupillary distance by driving the adjustment mechanism with a motor to move the left and right lens modules. However, the VR glasses in the related technology arrange the teeth of the two racks in the same direction and mesh with two output gears to achieve transmission. That is, one output rack meshes with one output gear to achieve transmission, driving the two racks to mesh with each other to achieve transmission. Due to the additional reversing transmission, there are disadvantages such as low space utilization, complex mechanisms, and inconsistent rack push-out forces, resulting in poor reliability of VR glasses.

Therefore, it is desirable to provide new VR glasses to solve the above technical problems.

### SUMMARY

The technical problem to be solved by the present disclosure is to provide VR glasses that can automatically and synchronously adjust the interpupillary distance, and has high adjustment accuracy, small volume occupation, high reliability, and good user experience.

To solve the above technical problem, embodiments of the present disclosure provide VR glasses including a bracket body, a first mounting hole and a second mounting hole penetrating through the bracket body and spaced apart from each other, and a first lens module and a second lens module respectively mounted in the first mounting hole and the second mounting hole, where a transverse aperture of the first mounting hole is greater than a diameter of the first lens module, and a transverse aperture of the second mounting hole is greater than a diameter of the second lens module. The VR glasses include a driving module fixed to the bracket body and located between the first lens module and the second lens module, and the driving module is configured to drive the first lens module and the second lens module to synchronously move towards each other or away from each other to realize interpupillary distance adjustment.

The driving module includes a frame fixed to the bracket body, a driving unit fixed to one side of the frame, a gear member rotatably disposed in the frame and torque-transmissively connected to the driving unit, a first rack meshed with the gear member, and a second rack meshed with the gear member, where the first rack is configured to oppose the second rack, and the first rack and the second rack are respectively in sliding connection with the frame. An end of the first rack away from the gear member is fixed to the first lens module, and an end of the second rack away from the gear member is fixed to the second lens module.

In some embodiments, the first rack and the second rack are parallel to each other and perpendicular to an axial direction of the driving unit, and the first rack and the second rack are configured to move at a same speed.

In some embodiments, the VR glasses further include a first flexible damping mechanism and a second flexible damping mechanism opposing each other, where an end of the first flexible damping mechanism close to the driving module is hinged to the first rack, and an end of the first flexible damping mechanism away from the driving module is fixed to the first lens module; and an end of the second flexible damping mechanism close to the driving module is hinged to the second rack, and an end of the second flexible damping mechanism away from the driving module is fixed to the second lens module.

In some embodiments, the first flexible damping mechanism includes a first hinge portion, a first limiting slot recessed at an end of the first hinge portion away from the first rack, a first guide rod disposed in the first limiting slot, a first spring and a second spring sleeved on the first guide rod, and a first nut fixed to an end of the first guide rod away from the first rack; where the first guide rod is in sliding connection with the first lens module, and the first nut is located on a side of the first lens module away from the frame; and the first spring is located in the first limiting slot, and the second spring is located between the first hinge portion and the first lens module; the second flexible damping mechanism includes a second hinge portion, a second limiting slot recessed at an end of the second hinge portion away from the second rack, a second guide rod disposed in the second limiting slot, a third spring and a fourth spring sleeved on the second guide rod, and a second nut fixed to an end of the second guide rod away from the second rack; the second guide rod is in sliding connection with the second lens module, and the second nut is located on a side of the second lens module away from the frame; and the third spring is located in the second limiting slot, and the fourth spring is located between the second hinge portion and the second lens module.

In some embodiments, the first lens module includes a first lens barrel disposed in the first mounting hole, a first lens group fixed inside the first lens barrel, and a first connecting portion protruding from an outer wall of the first lens barrel; a first guide through hole is formed in the first connecting portion, the first guide rod is disposed in the first guide through hole, the second spring is disposed between the first hinge portion and the first connecting portion, and the first nut is disposed on a side of the first connecting portion away from the frame and configured to abut against the first connecting portion; the second lens module includes a second lens barrel disposed in the second mounting hole, a second lens group fixed inside the second lens barrel, and a second connecting portion protruding from an outer wall of the second lens barrel; a second guide through hole is formed in the second connecting portion, the second guide rod is disposed in the second guide through hole, the fourth spring is disposed between the second hinge portion and the second connecting portion, and the second nut is disposed on a side of the second connecting portion away from the frame and configured to abut against the second connecting portion.

In some embodiments, the frame includes a frame body fixed to one side of the bracket body, an extension portion extending from one side of the frame body close to the first lens module, a through hole penetrating through the extension portion, a groove recessed from one side of the frame body close to the bracket body towards a direction away from the bracket body, and a first sliding slot and a second sliding slot respectively penetrating through the frame body and communicating with the groove; the driving unit is fixed in the through hole, the gear member is disposed in the groove, and the first rack and the second rack are respectively disposed in the first sliding slot and the second sliding slot.

In some embodiments, the VR glasses further include a multi-stage planetary gearbox, where an input end of the multi-stage planetary gearbox is fixedly connected to the driving unit, and an output end of the multi-stage planetary gearbox is fixedly connected to the gear member; and the multi-stage planetary gearbox is disposed in the through hole.

In some embodiments, the gear member includes a rotating shaft fixed to the output end of the multi-stage planetary gearbox and a gear structure fixedly sleeved on the rotating shaft; where the gear structure is located in the groove, and the gear structure is configured to respectively mesh with the first rack and the second rack.

In some embodiments, the VR glasses further include a steel sheet, and the frame body is provided with a first counterbore corresponding to an end of the rotating shaft away from the driving unit; where a side of the frame body away from the bracket body is recessed to form a mounting slot, the steel sheet is inserted into the mounting slot, the rotating shaft is disposed to extend through the first counterbore, and an end of the rotating shaft close to the steel sheet is configured to abut against the steel sheet.

In some embodiments, the VR glasses further include a bearing, where the bearing is fixed in the first counterbore, an end of the rotating shaft is fixed in the bearing, and the other end of the rotating shaft is fixed to the output end of the driving unit.

Compared with the related art, in the VR glasses of the present disclosure, the driving module is utilized to drive the first lens module and the second lens module to synchronously move towards each other or away from each other to realize interpupillary distance adjustment. The driving module includes a frame fixed to the bracket body, a driving unit fixed to one side of the frame, a gear member rotatably disposed in the frame and torque-transmissively connected to the driving unit, a first rack meshed with the gear member, and a second rack meshed with the gear member, where the first rack is configured to oppose the second rack, and the first rack and the second rack are respectively in sliding connection with the frame. An end of the first rack away from the gear member is fixed to the first lens module, and an end of the second rack away from the gear member is fixed to the second lens module. The output end of the driving unit drives the gear member to drive the first rack and the second rack to move, so that the first rack and the second rack synchronously move towards or away from each other, achieving automatic adjustment of the interpupillary distance between the first lens module and the second lens module. Such configuration has high adjustment accuracy, small volume occupation, high reliability, and good user experience.

### BRIEF DESCRIPTION OF THE DRAWINGS

In order to illustrate the technical solutions in the embodiments of the present disclosure more clearly, the drawings used in the description of the embodiments are briefly described below. It is apparent that the drawings in the following description show only some embodiments of the present disclosure, and other drawings may be obtained by those of ordinary skill in the art based on these drawings without any creative efforts.

FIG. 1 is a structural schematic diagram of VR glasses of the present disclosure;

FIG. 2 is an exploded view of FIG. 1;

FIG. 3 is a front view of the VR glasses, without a head mount, of FIG. 1;

FIG. 4 is a structural schematic diagram of lens modules of the present disclosure;

FIG. 5 is a structural schematic diagram of a driving module of the VR glasses of the present disclosure;

FIG. 6 is an exploded view of FIG. 5;

FIG. 7 is a cross-sectional view of FIG. 5, taken along line A-A; and

FIG. 8 is a structural schematic diagram of a frame of the present disclosure.

Reference numerals in the accompanying drawings are listed as follows: 100 VR glasses, 1 bracket body, 101 fixing column, 102 head mount, 103 locking piece, 104 stop sheet, 105 eye mask, 2 first mounting hole, 3 second mounting hole, 4 first lens module, 41 first lens barrel, 42 first lens group, 43 first connecting portion, 431 first guide through hole, 5 second lens module, 51 second lens barrel, 52 second lens group, 53 second connecting portion, 531 second guide through hole, 6 driving module, 61 frame, 611 frame body, 612 extension portion, 613 through hole, 614 groove, 615 first sliding slot, 616 second sliding slot, 617 mounting slot, 618 first counterbore, 62 driving unit, 63 gear member, 631 rotating shaft, 632 gear structure, 64 first rack, 65 second rack, 7 first flexible damping mechanism, 71 first hinge portion, 72 first limiting slot, 73 first guide rod, 74 first spring, 75 second spring, 76 first nut, 8 second flexible damping mechanism, 81 second hinge portion, 82 second limiting slot, 83 second guide rod, 84 third spring, 85 fourth spring, 86 second nut, 9 multi-stage planetary gearbox, 10 steel sheet, 11 bearing.

### DETAILED DESCRIPTION OF THE EMBODIMENTS

The technical solutions in the embodiments of the present disclosure are clearly and comprehensively described below with reference to the accompanying drawings of the embodiments of the present disclosure. Apparently, the embodiments described herein are merely a subset of the embodiments of the present disclosure, not exhaustive. Based on the embodiments of the present disclosure, all other embodiments obtained by those of ordinary skill in the art without creative efforts fall within the scope of protection of the present disclosure.

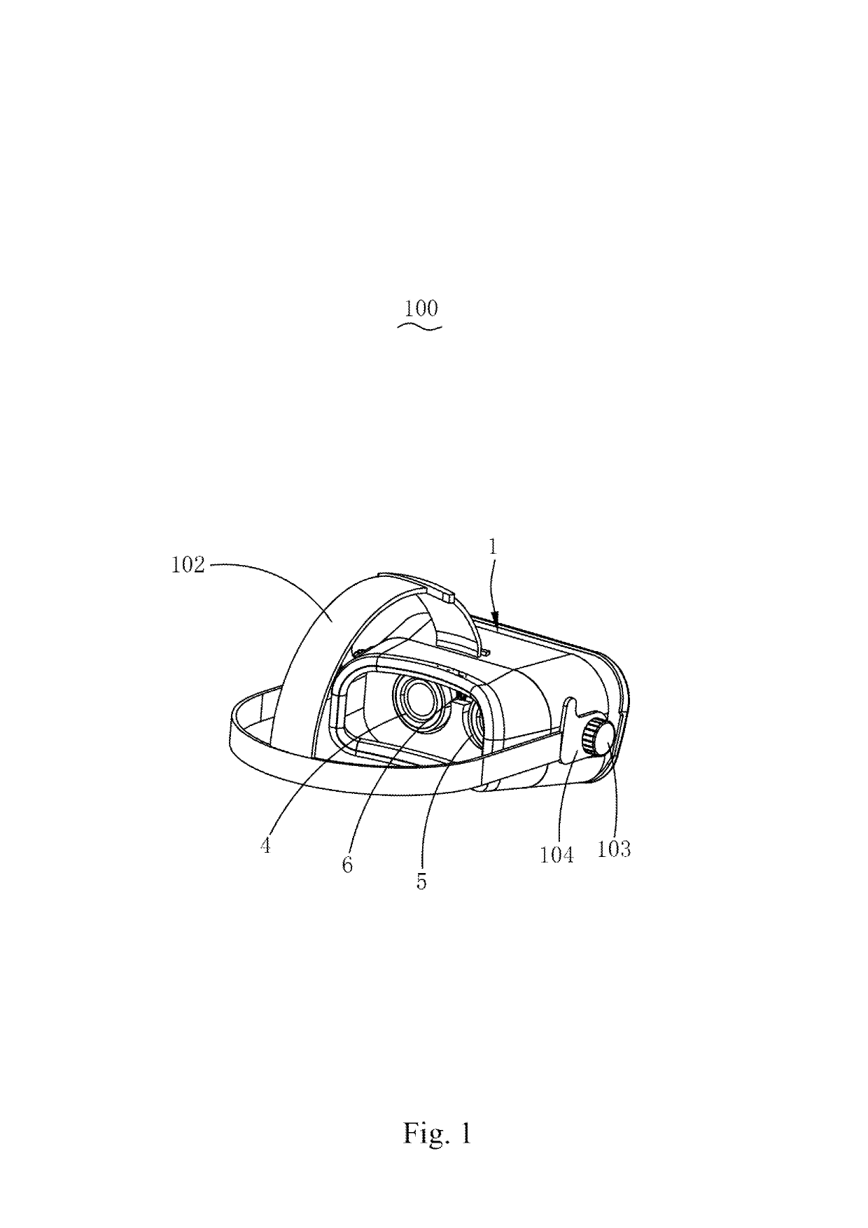

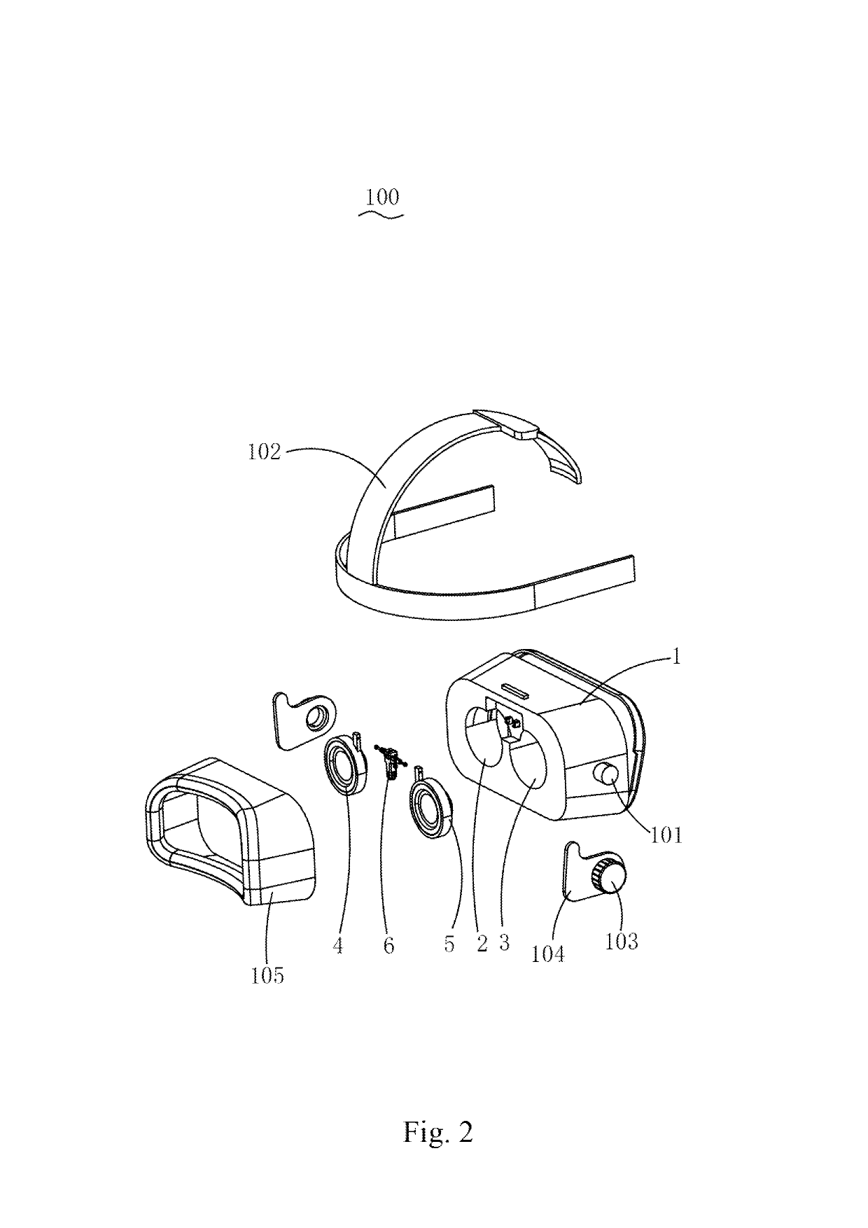

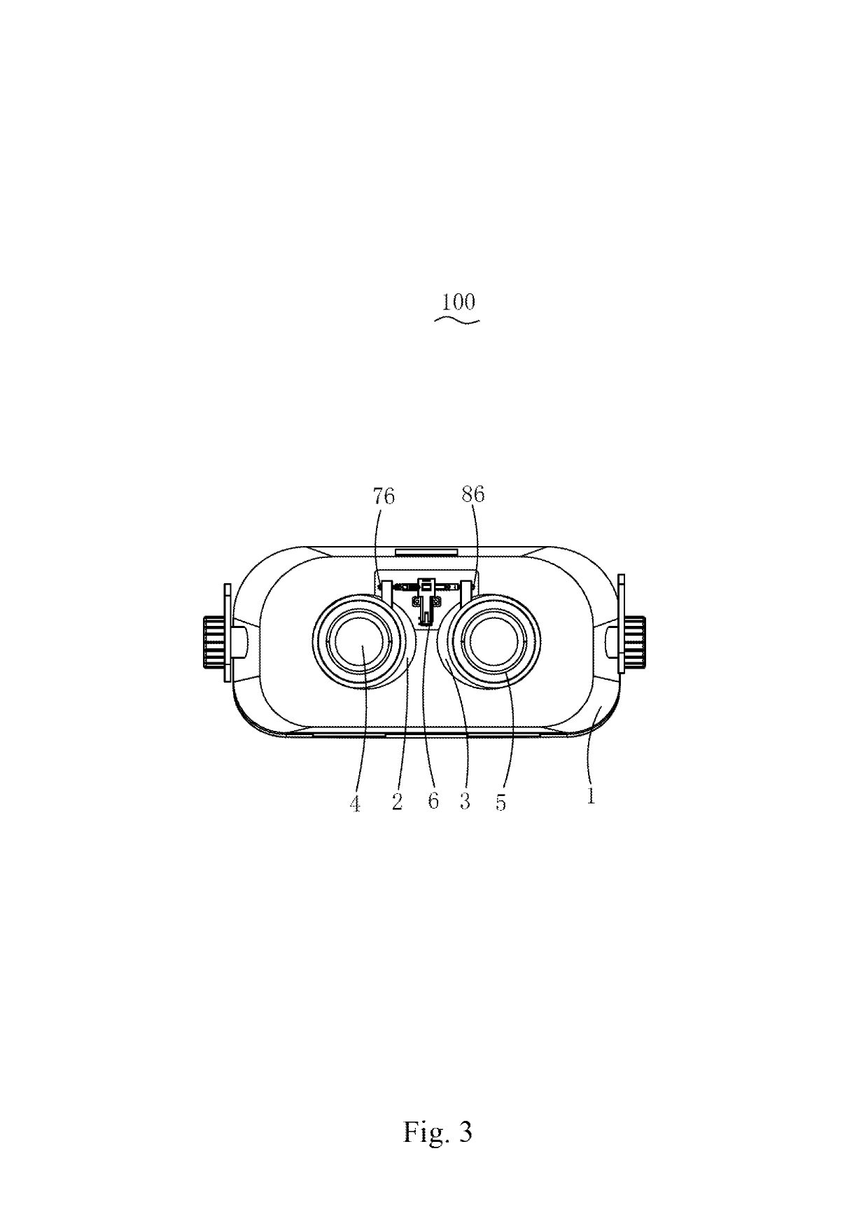

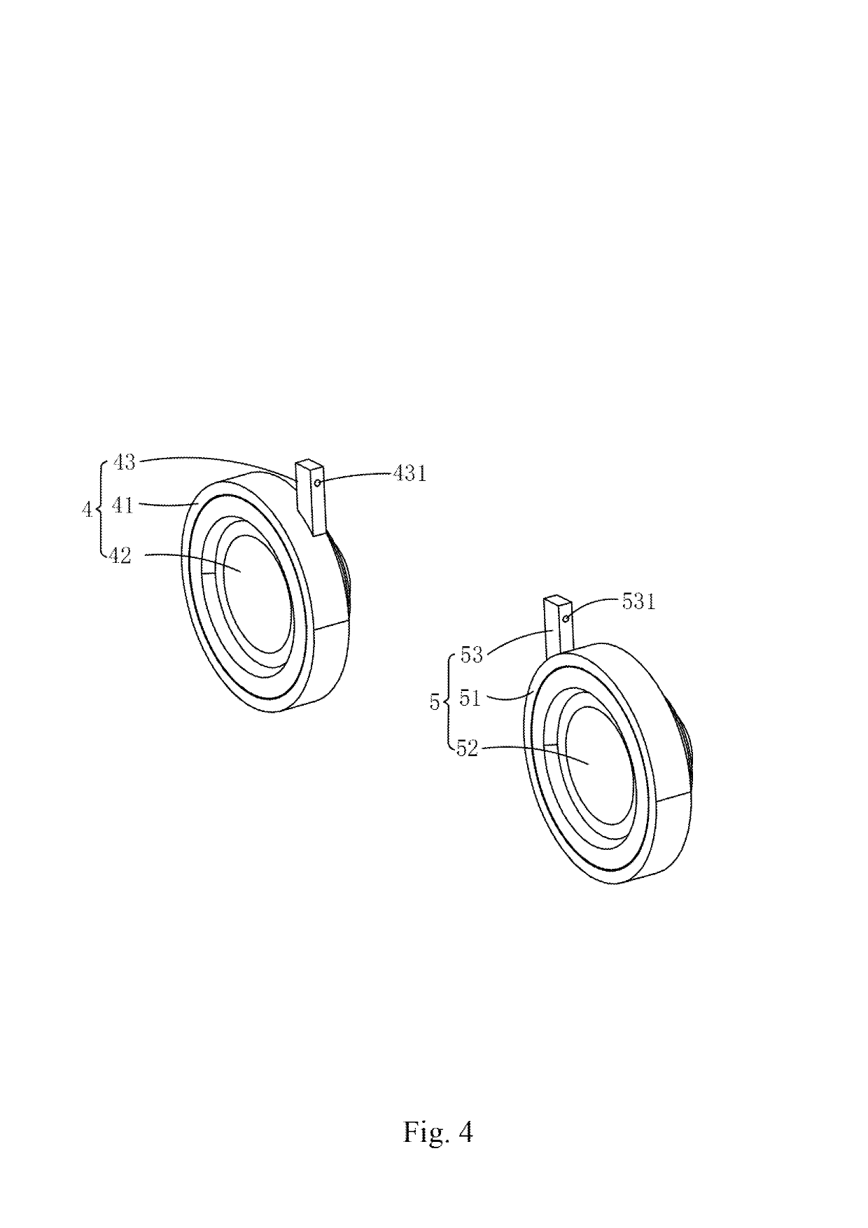

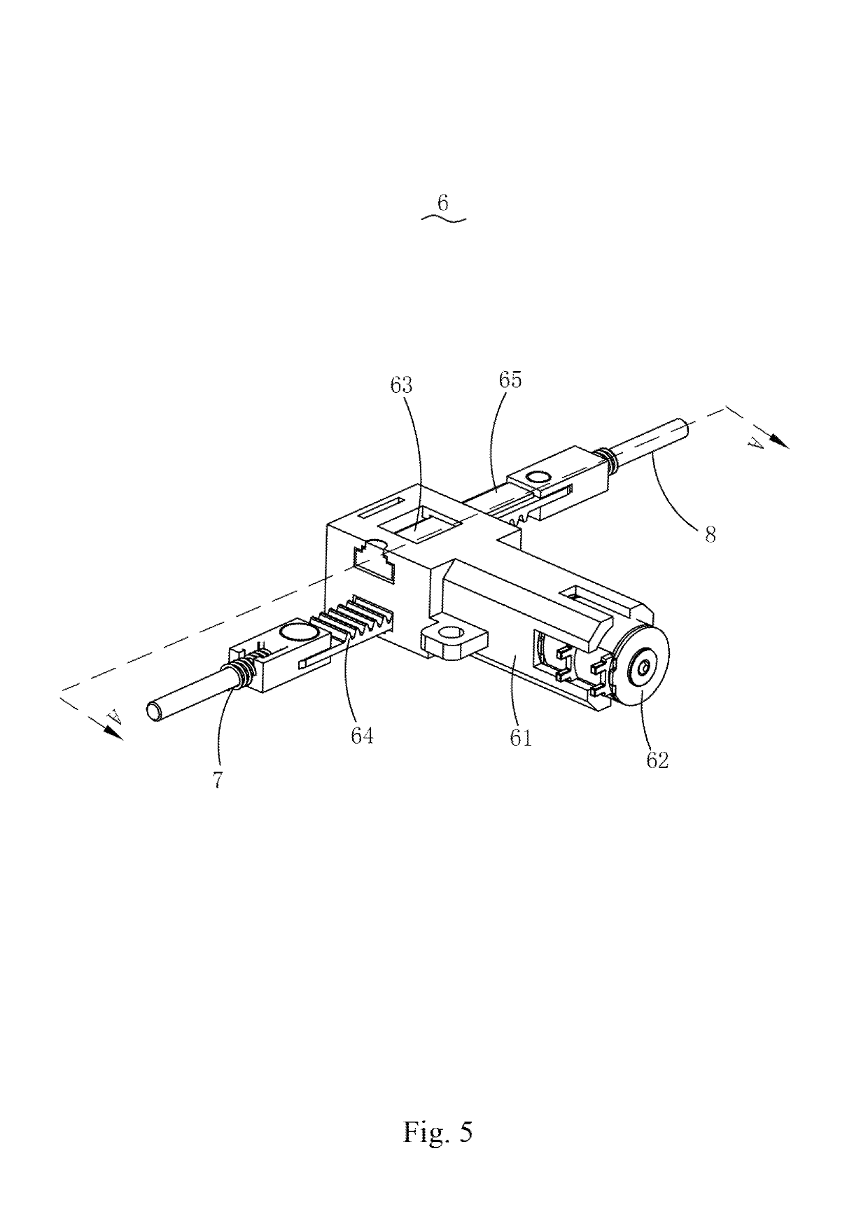

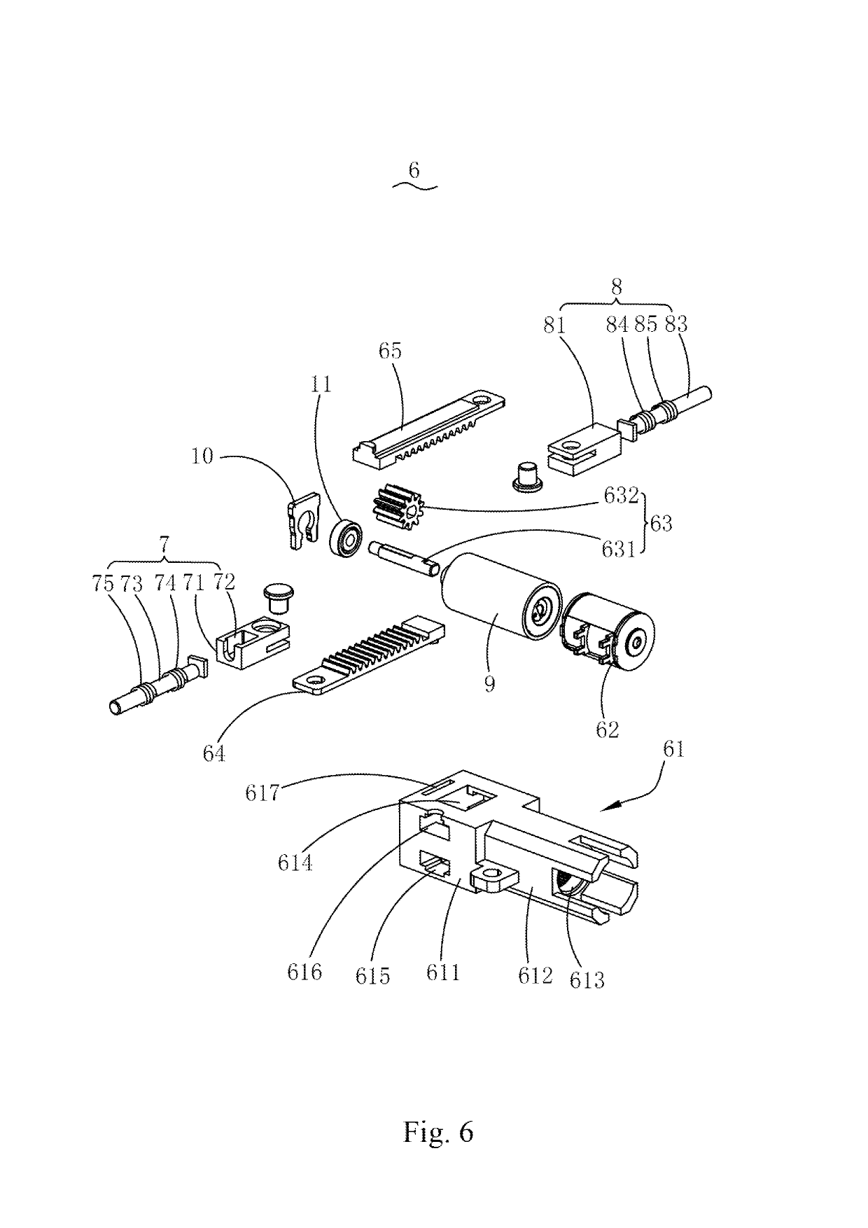

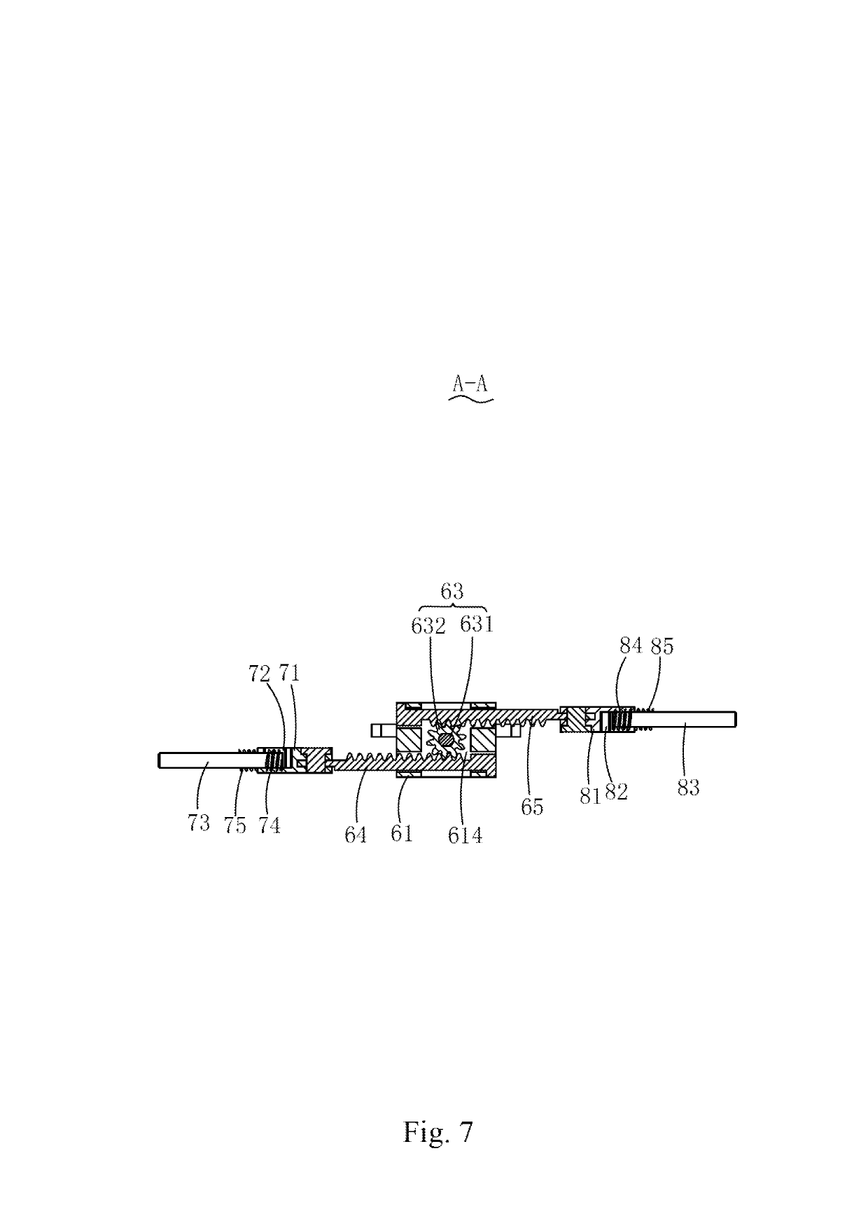

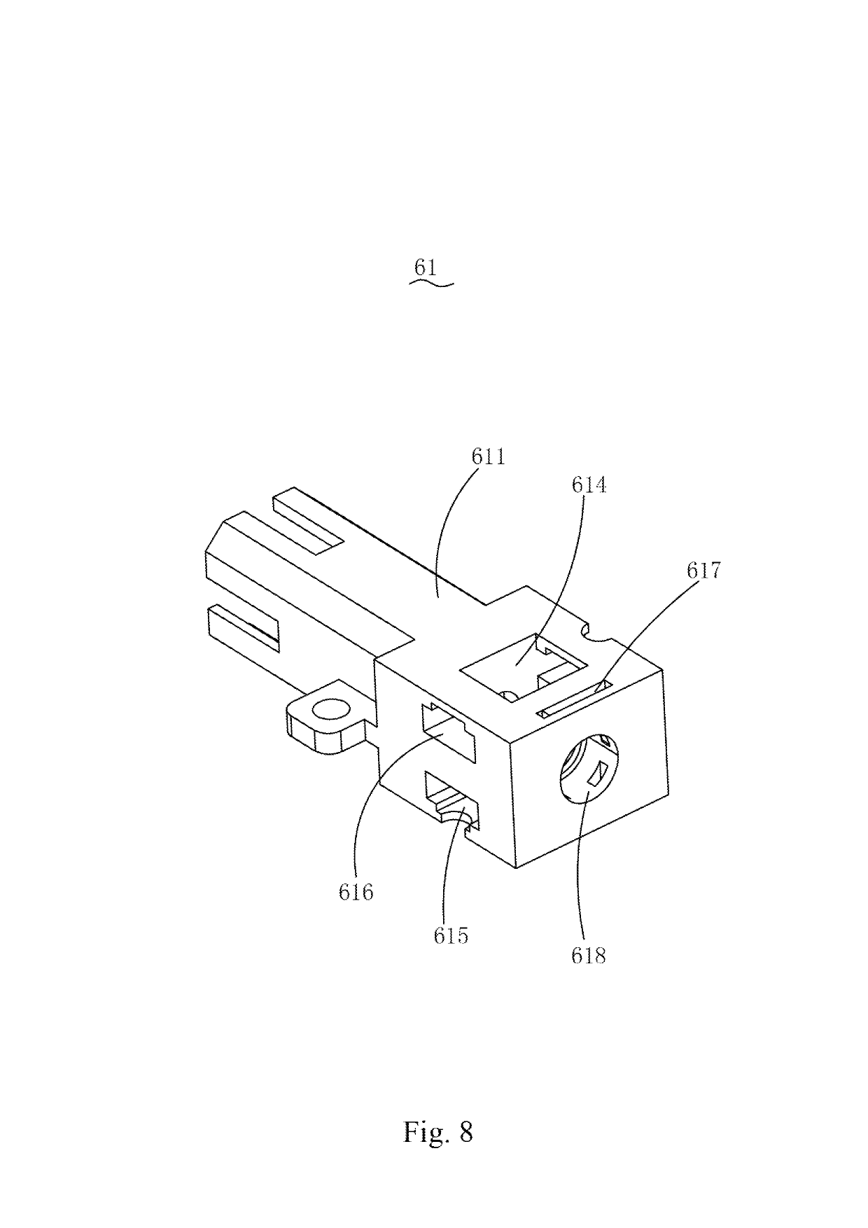

Referring to FIGS. 1-8, embodiments of the present disclosure provide VR glasses 100 including a bracket body 1, a first mounting hole 2 and a second mounting hole 3 penetrating through the bracket body 1 and spaced apart from each other, and a first lens module 4 and a second lens module 5 respectively mounted in the first mounting hole 2 and the second mounting hole 3, where a transverse aperture of the first mounting hole 2 is greater than a diameter of the first lens module 4, and a transverse aperture of the second mounting hole 3 is greater than a diameter of the second lens module 5. The VR glasses 100 further include a driving module 6 fixed to the bracket body 1 and located between the first lens module 4 and the second lens module 5, and the driving module 6 is configured to drive the first lens module 4 and the second lens module 5 to synchronously move towards each other or away from each other to realize interpupillary distance adjustment.

The VR glasses further include an eye mask 105 fixed to the bracket body 1, a fixing column 101 relatively fixed to two sides of the bracket body 1, a stop sheet 104 sleeved on the fixing column 101, a head mount 102 sleeved on a side of the fixing column 101 away from the stop sheet 104, and a locking piece 103 fixing the head mount 102 to the fixing column 101. The head mount 102 is placed on the user's head, with the left and right eyes corresponding to the first lens module 4 and the second lens module 5 respectively, and fixed by the locking piece 103.

The driving module 6 includes a frame 61 fixed to the bracket body 1, a driving unit 62 fixed to one side of the frame 61, a gear member 63 rotatably disposed in the frame 61 and torque-transmissively connected to the driving unit 62, a first rack 64 meshed with the gear member 63, and a second rack 65 meshed with the gear member 63, where the first rack 64 is configured to oppose the second rack 65, and the first rack 64 and the second rack 65 are respectively in sliding connection with the frame 61. An end of the first rack 64 away from the gear member 63 is fixed to the first lens module 4, and an end of the second rack 65 away from the gear member 63 is fixed to the second lens module 5. The output end of the driving unit 62 drives the gear member 63 to drive the first rack 64 and the second rack 65 to move, so that the first rack 64 and the second rack 65 synchronously move towards or away from each other, achieving automatic adjustment of the interpupillary distance between the first lens module 4 and the second lens module 5. Such configuration has high adjustment accuracy, small volume occupation, high reliability, and good user experience.

Specifically, the first rack 64 and the second rack 65 are disposed to oppose each other, and the first rack 64 and the second rack 65 are simultaneously meshed with the gear member 63 to achieve transmission. When the gear member 63 rotates clockwise, it drives the first rack 64 to move linearly to the left and simultaneously drives the second rack 65 to move linearly to the right, reducing one stage of reversing transmission, improving transmission efficiency, and enhancing the consistency of rack push-out force. The spatial arrangement of the first rack 64 and the second rack 65 in a vertical manner has high space utilization, further simplifies the mechanism, and improves assembly efficiency.

In some embodiments, the frame 61 is detachably fixedly connected to the bracket body 1, facilitating the maintenance or replacement of the driving module 6. The frame 61 is fixedly connected to one side of the bracket body 1 by screws.

In some embodiments, the driving unit 62 is a stepper motor, a drive motor, etc. The driving unit 62 herein is configured as a stepper motor, which can control the lens adjustment speed by changing the pulse frequency through software, improving the user experience. However, the drive motor is not limited to a stepper motor, and other type of motor such as brush motor can also be used, depending on drive and cost requirements.

In this embodiment, the first rack 64 and the second rack 65 are parallel to each other and perpendicular to an axial direction of the driving unit 62, and the first rack 64 and the second rack 65 are configured to move at a same speed. The driving unit drives the parallel first rack 64 and second rack 65 via the gear member 63 to synchronously move in opposite directions and at a same speed.

In this embodiment, the VR glasses 100 further include a first flexible damping mechanism 7 and a second flexible damping mechanism 8 opposing each other, where an end of the first flexible damping mechanism 7 close to the driving module 6 is hinged to the first rack 64, and an end of the first flexible damping mechanism 7 away from the driving module 6 is fixed to the first lens module 4; and an end of the second flexible damping mechanism 8 close to the driving module 6 is hinged to the second rack 65, and an end of the second flexible damping mechanism 8 away from the driving module 6 is fixed to the second lens module 5. By arranging the teeth of the first rack 64 and the second rack 65 in opposite directions, the left and right rack drive portions drive at equal speeds and in opposite directions. By providing the first flexible damping mechanism 7 and the second flexible damping mechanism 8, bidirectional damping of movement of the rack can be achieved. Thus, the operation is more stable and softer, with strong impact resistance and high reliability.

In this embodiment, the first flexible damping mechanism 7 includes a first hinge portion 71, a first limiting slot 72 recessed at an end of the first hinge portion 71 away from the first rack 64, a first guide rod 73 disposed in the first limiting slot 72, a first spring 74 and a second spring 75 sleeved on the first guide rod 73, and a first nut 76 fixed to an end of the first guide rod 73 away from the first rack 64; where the first guide rod 73 is in sliding connection with the first lens module 4, and the first nut 76 is located on a side of the first lens module 4 away from the frame 61; and the first spring 74 is located in the first limiting slot 72, and the second spring 75 is located between the first hinge portion 71 and the first lens module 4.

In this embodiment, the second flexible damping mechanism 8 includes a second hinge portion 81, a second limiting slot 82 recessed at an end of the second hinge portion 81 away from the second rack 65, a second guide rod 83 disposed in the second limiting slot 82, a third spring 84 and a fourth spring 85 sleeved on the second guide rod 83, and a second nut 86 fixed to an end of the second guide rod 83 away from the second rack 65; the second guide rod 83 is in sliding connection with the second lens module 5, and the second nut 86 is located on a side of the second lens module 5 away from the frame 61; and the third spring 84 is located in the second limiting slot 82, and the fourth spring 85 is located between the second hinge portion 81 and the second lens module 5.

Specifically, the first rack 64 and the second rack 65 are respectively connected to the first lens module 4 and the second lens module 5 via flexible connections. The first spring 74 and the second spring 75 are pre-pressed on the first guide rod 73. When the motor drives the rack to extend out, the pressure of the second spring 75 increases while the pressure of the first spring 74 decreases. When the motor drives the rack to retract, the pressure of the first spring 74 increases while the pressure of the second spring 75 decreases, thus achieving bidirectional damping for movement of the lens. The provision of the first spring 74 and the second spring 75 provides a damping mechanism for the uneven instantaneous output during motor driving, creates a good appearance experience, and also provides a protection mechanism for the impact of external forces on the gears, reducing the risk of deformation of the gear teeth. Thus, the overall operation is more stable and softer, with improved impact resistance and reliability.

Besides, the third spring 84 and the fourth spring 85 are pre-pressed on the second guide rod 83. When the motor drives the rack to extend out, the pressure of the fourth spring 85 increases while the pressure of the third spring 84 decreases. When the motor drives the rack to retract, the pressure of the third spring 84 increases while the pressure of the fourth spring 85 decreases, thus achieving bidirectional damping for movement of the lens.

In this embodiment, the first lens module 4 includes a first lens barrel 41 disposed in the first mounting hole 2, a first lens group 42 fixed inside the first lens barrel 41, and a first connecting portion 43 protruding from an outer wall of the first lens barrel 41; a first guide through hole 431 is formed in the first connecting portion 43, the first guide rod 73 is disposed in the first guide through hole 431, the second spring 75 is disposed between the first hinge portion 71 and the first connecting portion 43, and the first nut 76 is disposed on a side of the first connecting portion 43 away from the frame 61 and configured to abut against the first connecting portion 43;

the second lens module 5 includes a second lens barrel 51 disposed in the second mounting hole 3, a second lens group 52 fixed inside the second lens barrel 51, and a second connecting portion 53 protruding from an outer wall of the second lens barrel 51; a second guide through hole 531 is formed in the second connecting portion 53, the second guide rod 83 is disposed in the second guide through hole 531, the fourth spring 85 is disposed between the second hinge portion 81 and the second connecting portion 53, and the second nut 86 is disposed on a side of the second connecting portion 53 away from the frame 61 and configured to abut against the second connecting portion 53.

In this embodiment, the frame 61 includes a frame body 611 fixed to one side of the bracket body 1, an extension portion 612 extending from one side of the frame body 611 close to the first lens module 4, a through hole 613 penetrating through the extension portion 612, a groove 614 recessed from one side of the frame body 611 close to the bracket body 1 towards a direction away from the bracket body 1, and a first sliding slot 615 and a second sliding slot 616 respectively penetrating through the frame body 611 and communicating with the groove 614; the driving unit 62 is fixed in the through hole 613, the gear member 63 is disposed in the groove 614, and the first rack 64 and the second rack 65 are respectively disposed in the first sliding slot 615 and the second sliding slot 616.

In this embodiment, the VR glasses 100 further include a multi-stage planetary gearbox 9, where an input end of the multi-stage planetary gearbox 9 is fixedly connected to the driving unit 62, and an output end of the multi-stage planetary gearbox 9 is fixedly connected to the gear member 63; and the multi-stage planetary gearbox 9 is disposed in the through hole 613.

In this embodiment, the gear member 63 includes a rotating shaft 631 fixed to the output end of the multi-stage planetary gearbox 9 and a gear structure 632 fixedly sleeved on the rotating shaft 631; where the gear structure 632 is located in the groove 614, and the gear structure 632 is configured to respectively mesh with the first rack 64 and the second rack 65.

In this embodiment, the VR glasses 100 further include a steel sheet 10, and the frame body 611 is provided with a first counterbore 618 corresponding to an end of the rotating shaft 631 away from the driving unit 62; where a side of the frame body 611 away from the bracket body 1 is recessed to form a mounting slot 617, the steel sheet 10 is inserted into the mounting slot 617, the rotating shaft 631 is disposed to extend through the first counterbore 618, and an end of the rotating shaft 631 close to the steel sheet 10 is configured to abut against the steel sheet 10.

In this embodiment, the VR glasses 100 further include a bearing 11, where the bearing 11 is fixed in the first counterbore 618, an end of the rotating shaft 631 is fixed in the bearing 11, and the other end of the rotating shaft 631 is fixed to the output end of the driving unit 62. The bearing 11 may be a ball bearing, and the tail of the rotating shaft 631 is fixed with a ball bearing. The bearing is fixed with a specially designed steel sheet 10. The rotating shaft 631 may be assembled with the frame body 611 through interference fit, and is externally isolated by the steel sheet 10. In the non-working state, the gear structure 632 does not drive the rotating shaft 631 to rotate reversely, so there is no need to use two bearings 11 to secure two ends of the rotating shaft 631, thus reducing the friction between the rotating shaft 631 and the bearing 11. The assembly of the bearing 11 and the frame body 611 reduces the cost of parts and assembly; and prevents large shape and position tolerances caused by a large number of parts, resulting in high precision and efficiency.

In the VR glasses of the present disclosure, the driving module is utilized to drive the first lens module and the second lens module to synchronously move towards each other or away from each other to realize interpupillary distance adjustment. The driving module includes a frame fixed to the bracket body, a driving unit fixed to one side of the frame, a gear member rotatably disposed in the frame and torque-transmissively connected to the driving unit, a first rack meshed with the gear member, and a second rack meshed with the gear member, where the first rack is configured to oppose the second rack, and the first rack and the second rack are respectively in sliding connection with the frame. An end of the first rack away from the gear member is fixed to the first lens module, and an end of the second rack away from the gear member is fixed to the second lens module. The output end of the driving unit drives the gear member to drive the first rack and the second rack to move, so that the first rack and the second rack synchronously move towards or away from each other, achieving automatic adjustment of the interpupillary distance between the first lens module and the second lens module. Such configuration has high adjustment accuracy, small volume occupation, high reliability, and good user experience.

The above description only shows embodiments of the present disclosure. It should be noted herein that for those skilled in the art, improvements may be made without departing from the inventive concept of the present disclosure, and those improvements still fall within the scope of protection of the present disclosure.

What is claimed is:

1. Virtual reality (VR) glasses, comprising a bracket body, a first mounting hole and a second mounting hole penetrating through the bracket body and spaced apart from each other, and a first lens module and a second lens module respectively mounted in the first mounting hole and the second mounting hole, wherein a transverse aperture of the first mounting hole is greater than a diameter of the first lens module, and a transverse aperture of the second mounting hole is greater than a diameter of the second lens module; the VR glasses further comprise a driving module fixed to the bracket body and located between the first lens module and the second lens module, and the driving module is configured to drive the first lens module and the second lens module to synchronously move towards each other or away from each other to realize interpupillary distance adjustment;
wherein the driving module comprises a frame fixed to the bracket body, a driving unit fixed to one side of the frame, a gear member rotatably disposed in the frame and torque-transmissively connected to the driving unit, a first rack meshed with the gear member, and a second rack meshed with the gear member, wherein the first rack is configured to oppose the second rack, and the first rack and the second rack are respectively in sliding connection with the frame; an end of the first rack away from the gear member is fixed to the first lens module, and an end of the second rack away from the gear member is fixed to the second lens module.

2. The VR glasses according to claim 1, wherein the first rack and the second rack are parallel to each other and perpendicular to an axial direction of the driving unit, and the first rack and the second rack are configured to move at a same speed.

3. The VR glasses according to claim 1, wherein the VR glasses further comprise a first flexible damping mechanism and a second flexible damping mechanism opposing each other; wherein an end of the first flexible damping mechanism close to the driving module is hinged to the first rack, and an end of the first flexible damping mechanism away from the driving module is fixed to the first lens module; and an end of the second flexible damping mechanism close to the driving module is hinged to the second rack, and an end of the second flexible damping mechanism away from the driving module is fixed to the second lens module.

4. The VR glasses according to claim 3, wherein the first flexible damping mechanism comprises a first hinge portion, a first limiting slot recessed at an end of the first hinge portion away from the first rack, a first guide rod disposed in the first limiting slot, a first spring and a second spring sleeved on the first guide rod, and a first nut fixed to an end of the first guide rod away from the first rack; wherein the first guide rod is in sliding connection with the first lens module, and the first nut is located on a side of the first lens module away from the frame; and the first spring is located in the first limiting slot, and the second spring is located between the first hinge portion and the first lens module;
the second flexible damping mechanism comprises a second hinge portion, a second limiting slot recessed at an end of the second hinge portion away from the second rack, a second guide rod disposed in the second limiting slot, a third spring and a fourth spring sleeved on the second guide rod, and a second nut fixed to an end of the second guide rod away from the second rack; the second guide rod is in sliding connection with the second lens module, and the second nut is located on a side of the second lens module away from the frame; and the third spring is located in the second limiting slot, and the fourth spring is located between the second hinge portion and the second lens module.

5. The VR glasses according to claim 4, wherein the first lens module comprises a first lens barrel disposed in the first mounting hole, a first lens group fixed inside the first lens barrel, and a first connecting portion protruding from an outer wall of the first lens barrel; a first guide through hole is formed in the first connecting portion, the first guide rod is disposed in the first guide through hole, the second spring is disposed between the first hinge portion and the first connecting portion, and the first nut is disposed on a side of the first connecting portion away from the frame and configured to abut against the first connecting portion;
the second lens module comprises a second lens barrel disposed in the second mounting hole, a second lens group fixed inside the second lens barrel, and a second connecting portion protruding from an outer wall of the second lens barrel; a second guide through hole is formed in the second connecting portion, the second guide rod is disposed in the second guide through hole, the fourth spring is disposed between the second hinge portion and the second connecting portion, and the second nut is disposed on a side of the second connecting portion away from the frame and configured to abut against the second connecting portion.

6. The VR glasses according to claim 1, wherein the frame comprises a frame body fixed to one side of the bracket body, an extension portion extending from one side of the frame body close to the first lens module, a through hole penetrating through the extension portion, a groove recessed from one side of the frame body close to the bracket body towards a direction away from the bracket body, and a first sliding slot and a second sliding slot respectively penetrating through the frame body and communicating with the groove; the driving unit is fixed in the through hole, the gear member is disposed in the groove, and the first rack and the second rack are respectively disposed in the first sliding slot and the second sliding slot.

7. The VR glasses according to claim 6, wherein the VR glasses further comprise a multi-stage planetary gearbox, wherein an input end of the multi-stage planetary gearbox is fixedly connected to the driving unit, and an output end of the multi-stage planetary gearbox is fixedly connected to the gear member; and the multi-stage planetary gearbox is disposed in the through hole.

8. The VR glasses according to claim 7, wherein the gear member comprises a rotating shaft fixed to the output end of the multi-stage planetary gearbox and a gear structure fixedly sleeved on the rotating shaft; wherein the gear structure is located in the groove, and the gear structure is configured to respectively mesh with the first rack and the second rack.

9. The VR glasses according to claim 8, wherein the VR glasses further comprise a steel sheet, and the frame body is provided with a first counterbore corresponding to an end of the rotating shaft away from the driving unit; wherein a side of the frame body away from the bracket body is recessed to form a mounting slot, the steel sheet is inserted into the mounting slot, the rotating shaft is disposed to extend through the first counterbore, and an end of the rotating shaft close to the steel sheet is configured to abut against the steel sheet.

10. The VR glasses according to claim 9, wherein the VR glasses further comprise a bearing, wherein the bearing is fixed in the first counterbore, an end of the rotating shaft is fixed in the bearing, and the other end of the rotating shaft is fixed to the output end of the driving unit.
